(19) United States
(12) Patent Application Publication
(10) Pub. No.: US 2025/0046857 A1
(43) Pub. Date: Feb. 6, 2025

(54) Lithium Battery Cells

(71) Applicant: BLUE DOLPHIN (UK) LIMITED, Mayford Surrey (GB)

(72) Inventor: Daniel Horstman, Mayford Surrey (GB)

(21) Appl. No.: 18/716,177

(22) PCT Filed: Dec. 2, 2022
(86) PCT No.: PCT/GB2022/053059

§ 371 Date: Jun. 4, 2024

(30) Foreign Application Priority Data
Dec. 4, 2021 (GB) 2117560.9

(51) Int. Cl. H01M 10/0525; H01M 50/103; H01M 50/105; H01M 50/107; H01M 50/119; H01M 50/121; H01M 50/124; H01M 50/15; H01M 50/152; H01M 50/159; H01M 50/167; H01M 50/184; H01M 50/567

(52) U.S. Cl. CPC H01M 10/0525; H01M 50/103; H01M 50/105; H01M 50/107; H01M 50/119; H01M 50/121; H01M 50/1243; H01M 50/15; H01M 50/152; H01M 50/159; H01M 50/167; H01M 50/184; H01M 50/567

(57) ABSTRACT

A lithium cell includes a casing, positive and negative electrodes within the casing, a separator between the electrodes, an electrolyte, a positive terminal connected to one of the electrodes, and a negative terminal connected to the other of the electrodes. The casing is aluminium with a plastic material coating on its inner surface to prevent contact between the aluminium casing and the internal active components of the lithium cell. At least one of the terminals includes a metal component secured to the aluminium casing. The metal component is less susceptible to lithiation than the aluminium of the casing.

### CROSS-REFERENCE TO RELATED APPLICATIONS

This is the U.S. National Stage application of International Application No. PCT/GB2022/053059, filed Dec. 2, 2022, which claims the benefit of priority from GB 2117560.9, filed Dec. 4, 2021. The entire contents of these prior applications are incorporated by reference.

### FIELD

This invention pertains generally to the field of lithium battery cells, and is concerned particularly, although not exclusively, with the shells or casings of cylindrical, rechargeable lithium-ion cells.

### BACKGROUND

A lithium-ion, or Li-ion, battery is one type of rechargeable battery that is typically used for portable electronics devices and electric vehicles, while also finding use within aerospace and military devices and vehicles. Each lithium-ion battery is made up of a collection of cells or cell assemblies. A battery is the generic term for an electrochemical source of electricity, which stores energy in a chemically bound form, and which can convert this directly into electric power. A battery may be either a single cell or multiple cells connected in series/parallel configurations. The three primary functional components of a lithium-ion cell are a positive electrode, a negative electrode and electrolyte. Typically, the negative electrode of a conventional lithium-ion cell is made from carbon, the positive electrode is a metal oxide and the electrolyte comprises of lithium salt in an organic solvent.

Inside each cell the lithium ions move from the negative electrode through an electrolyte to the positive electrode when discharging, and from the positive electrode back through the electrolyte to the negative electrode when charging. The electrochemical roles of the electrodes reverse between anode and cathode, depending on the direction of current flow through the cell. Typically, these Li-ion cells comprise intercalated lithium compound for the positive electrode and graphite for the negative electrode. These cells have a high energy density, little to no memory effect and low self-discharge which supports their suitability for numerous applications. They do however present safety issues because they contain flammable electrolytes, and the fact that pure lithium is highly reactive. Thus, a non-aqueous electrolyte, such as an organic solvent, is typically used, and a sealed container rigidly excludes moisture from the battery.

Handheld electronics typically use lithium polymer batteries, where the electrolyte comprises a polymer gel, the cathode comprises lithium cobalt oxide and the anode comprises graphite. This provides a high energy density option. Other alternatives for the anode or cathode have included lithium iron phosphate, lithium manganese oxide and lithium nickel manganese cobalt oxide (NMC) which are thought to offer a better rate and longer life, making them preferential for medical devices and electric power tools, with NMC being used in electric vehicles.

The market for lithium-ion batteries is considerable and growing rapidly, with the drive towards using renewable energy sources over and above non-renewables. Li-ion batteries are a generic name for a large number of different battery chemistries with varying properties and performance and therefore also suited for a wide range of products. At present, the development of lithium-ion batteries is mainly driven by the automotive industry and their need for an improved energy storage solution for their electric and hybrid vehicles. However, for lithium-ion batteries it is key that they at least match in performance to non-renewable alternatives. Global organisations are conducting considerable research to improve upon existing lithium-ion cells, with the aim to extend battery life, increase charging speed, and/or increase energy density while improving safety and reducing cost, if possible. Another focus has been to reduce the mass of each individual cell. With some batteries comprising a considerable number of cells in each, a very small reduction in mass to each cell becomes a considerable reduction in mass across the whole battery.

Lithium-ion cells come in various shapes and constructions, with the two most common being cylinders and pouches. Cells with a cylindrical shape comprise a single long ‘sandwich’ of the positive electrode, separator, negative electrode, and separator rolled into a single spool. In pouches the electrodes are stacked. One advantage of cylindrical cells compared to cells with stacked electrodes is faster production speed. One disadvantage of cylindrical cells can be a large radial temperature gradient inside the cells developing at high discharge currents. The temperature gradient and volatile nature of the electrolytes dictate the choice of materials used to make up the cylinder or pouch. A lighter weight material, while helping to decrease the overall mass of each cell, may not be able to tolerate these high temperatures and may also be susceptible to lithiation.

Both in cylinder and pouch form, lithium-ion batteries typically have two terminals, one for each electrode. They distribute the current flowing into or out of the electrodes. The electrodes account for a considerable proportion of the overall mass of the battery. With mass reduction being a key focus, many organisations are exploring material options, and ways to reduce the mass of these electrodes. Attempts have been made to make them thinner or more porous, but both these options have tended to expose unwanted side effects, such as fragility, making the battery chemically unstable or requiring more electrolyte which may raise the unit cost. A reduction in overall battery weight enables lighter devices, and the load for an electric vehicle to carry. Storing more energy for a given mass allows these electric vehicles, and of course other devices, to last longer between charges.

Any reduction in mass does not just help to improve performance of the device or vehicle. It also impacts on the transportation of the batteries themselves, both to manufacturers and at end-of-life for recycling.

There is a need to reduce the mass of lithium-ion cells while maintaining optimum performance, and without creating unwanted side effects. There is a need to reduce the mass of lithium-ion cells while addressing safety concerns with flammability and suchlike, and without considerably impacting unit cost. There is a need to reduce the mass of lithium-ion cells without introducing major changes to current manufacturing processes.

The prior art shows a number of devices which attempt to address these needs in various ways.

CN 103 400 945 (Zhoushan Xinlong Electronic Equipment Co Ltd) discloses a housing for a cylindrical lithium-ion battery where the housing comprises an aluminium shell. The aluminium shell is provided with insulating layers on the inner wall and outer wall, that comprises a polyurethane coating. The coating allows for a smaller diameter, and a larger length to diameter ratio and therefore a battery of the same electrical capacity can be smaller in size. This coating on the inner wall is there to prevent internal short circuits, thereby improving battery efficiency. It is not to protect the aluminium shell from lithiation. The coating is also applied to both the inner wall and the outer wall at the same time, thereby adding unnecessary mass to the shell and the resulting lithium-ion battery.

CN 105 720 297 (Shenzhen Liwei Li-Energy Tech Co Ltd) discloses a lithium-ion cell comprising a metal case, with the inner wall coated with carbon. This inner wall is used as the container of the cell core and the electrolyte, while also providing the collector for the anode, improving cell capacity and performance without increasing cell size. This carbon coated inner wall does not incorporate carbon as a means of protecting the container from the effects of lithiation. The carbon forms the negative electrode collector.

### BRIEF SUMMARY

While the prior art appears to address the issue of reducing cell size and or mass, while maintaining, or even improving, electrical capacity, many of these proposals require complex manufacturing techniques that differ greatly from current manufacturing practices. These new methods would likely increase unit cost per cell to manufacture.

Preferred embodiments of the present invention aim to provide a reduction in mass while maintaining standard sizes of lithium-ion cells, without affecting electrical capacity and therefore performance of these cells, and without requiring complex manufacturing techniques, thereby ensuring little to no increase in unit cost per cell.

According to one aspect of the present invention, there is provided a lithium cell comprising:
a casing;
positive and negative electrodes disposed within the casing with a separator between the electrodes;
an electrolyte;
a positive terminal connected to one of the electrodes; and
a negative terminal connected to the other of the electrodes:
wherein:
the casing is of aluminium and is provided on its inner surface with a coating of a plastics material to prevent contact between the aluminium casing and the internal active components of the lithium cell; and
at least one of the terminals comprises a metal component that is secured to the aluminium casing such that the metal component is in electrical contact with the aluminium casing, the metal of the component being less susceptible to lithiation than the aluminium of the casing.

Preferably, said metal component passes through a hole in the aluminium casing and has a head that engages with the internal plastics coating of the cell to provide a seal between the coated inner surface of the casing and the outer surface of the casing.

Preferably, said metal component is a rivet that is riveted to the aluminium casing.

Preferably, said plastics coating is a spray-applied coating inside the aluminium casing.

Preferably, wherein one of the terminals comprises a steel cap that is secured to the aluminium casing.

Preferably, the steel cap is secured to the aluminium casing by swaging.

Preferably, said steel cap provides said positive terminal.

Preferably, the lithium cell is of cylindrical configuration.

Preferably, said casing is cylindrical with one open end and one closed end, and said metal component is secured to said closed end.

Preferably, the closed end of said casing is formed with an external recess within which an end of said metal component is located.

A lithium cell as above may be of prismatic or pouch configuration.

Preferably, said plastics coating comprises a polymer plastic.

Preferably, said metal component provides said negative terminal.

Preferably, the lithium cell is a rechargeable lithium-ion cell.

The invention extends to a lithium battery comprising a plurality of lithium cells according to any of the preceding aspects of the invention.

A method of manufacturing a lithium cell according to any of the preceding aspects of the invention, including the steps of fitting a metal rivet to the aluminium casing and welding an electrode tab to the metal rivet.

The invention extends to an aluminium casing with metal component for use in a lithium cell according to any of the preceding aspects of the invention.

The invention extends to a method of manufacturing an aluminium casing as above, including the steps of forming the aluminium casing and fitting a metal rivet to the aluminium casing.

The invention extends to a lithium cell, battery, method or casing according to any of the preceding aspects of the invention, wherein the metal of said component or rivet comprises steel.

### BRIEF DESCRIPTION OF THE DRAWINGS

For a better understanding of the invention and to show how embodiments of the same may be carried into effect, reference will now be made, by way of example, to the accompanying diagrammatic drawings, in which:

FIG. 1 shows a typical cylindrical lithium-ion cell of largely known configuration in isometric view, with a cutaway portion showing a ‘Swiss-roll’ configuration of positive and negative electrodes with separators that make up the core of the cell;

FIG. 2A shows one embodiment of a casing for a cylindrical lithium-ion cell in isometric view, showing a steel rivet secured to one end of the casing;

FIG. 2B shows the cylindrical casing of FIG. 2A in end view;

FIG. 3 shows the cylindrical casing of FIG. 2A in longitudinal section, showing one embodiment of coating on the inside of the casing;

FIG. 4 shows a section through one end of a lithium-ion cell, showing one embodiment of cap secured to an internally coated casing; and

FIG. 5 shows an alternative configuration with multiple electrodes with multiple tabs.

### DETAILED DESCRIPTION

In the figures like references denote like or corresponding parts.

It is to be understood that the various features that are described in the following and/or illustrated in the drawings are preferred but not essential. Combinations of features described and/or illustrated are not considered to be the only possible combinations. Unless stated to the contrary, individual features may be omitted, varied or combined in different combinations, where practical.

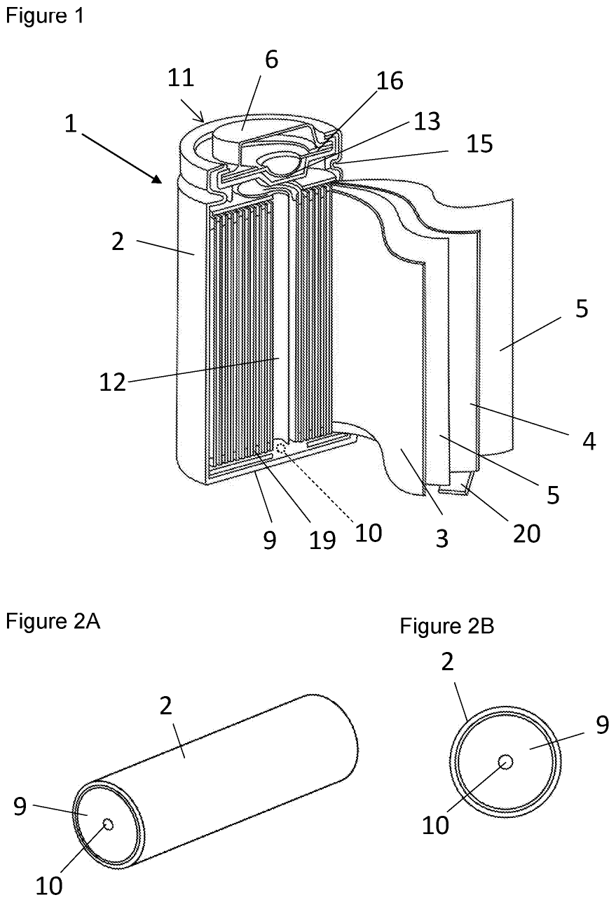

FIG. 1 shows a typical lithium-ion battery cell 1 with a casing 2, mostly of known construction. The casing 2 is often referred to as a ‘shell’. The casing 2 shown is cylindrical. The cutaway portion of FIG. 1 shows an electrode assembly comprising layers of positive electrodes 3 and layers of negative electrodes 4 rolled together, with separators 5 therebetween, all common elements within existing lithium-ion cells 1. Each separator 5 is a barrier which electrically insulates the positive electrode 3 from the negative electrode 4, preventing electrical internal short circuits. The separator 5 typically consists of 3 layers of polymer. When the cell 1 temperature becomes too high, the separator 5 breaks down and a short circuit may occur. This effect is irreversible.

Also shown in FIG. 1 and typical of existing Li-ion cells 1 is a cap assembly 11 that is secured to the top of the casing 2, and this cap 11 often includes components made from a material such as steel. The cap 11 is where a positive terminal 6 is located, the terminal 6 being typically made of steel. A negative terminal is formed by the other end 9 of the steel casing 2. The cap assembly 11 includes an insulative gasket 17 (FIG. 4).

As shown, at the positive terminal 6 of the cell 1 there are two mechanical protectors. These mechanical protectors comprise a Current Interrupt Device or CID 13 that is typically configured to trigger at a pressure of around 10 bar, and a Positive Temperature Coefficient element 16 or PTC that throttles the current at temperatures over 125° C. The CID 13 typically comprises a thin disc of sheet metal between the positive terminal 6, and the interior of the cell 1. The CID 13 incorporates a bowl-shaped depression in the center that presses down against another flat metal disc to make contact.

The CID 13 has two parts to its operation. The “triggering” is a break in electrical continuity, like a switch opening. It is only when the internal pressure becomes excessive does a diaphragm part of the CID actually rupture, allowing hot gases to escape into the atmosphere through vent holes/slots in the positive steel cap terminal 6. The CID 13 is a mechanical protector whose function is irreversible. The cell 1 will no longer work if this mechanical protector is triggered.

The PTC 16 increases in electrical resistance as the temperature rises—it has no moving parts as its function is due to its material properties. The PTC 16 limits the current coming out of an individual cell 1 when the tip of the cell 1 is getting hot. The PTC's 16 function is reversible and conduction restarts when the temperature falls. The CID 13 protects the cell under overcharge conditions and the PTC 16 protects the cell under external short conditions.

The casing 2 also contains an electrolyte 19. The electrolyte 19 may comprise a number of additives such as flame retardants or inhibitors. The casing 2 helps to secure the cell's 1 integrity against its surroundings.

Through the center of the cylinder is an elongate hole 12. A termination tab 20 of the negative electrode 4 layer of the cylindrical roll is typically welded to the bottom end 9 of the casing 2. In FIG. 1, the head of a rivet 10 is shown in broken line. Such a rivet is not a known feature of cells but forms part of an embodiment of the invention that is described in the following.

Typical casings 2 are made from steel that are nickel plated on both the inside and the outside. Both steel and nickel do not suffer lithiation when in contact with Lithium-ion chemistry. However, in order to reduce the overall weight of the lithium-ion cell 1, FIG. 2A shows a casing 2 made from an alternative lightweight metal, namely aluminium, as an example of an embodiment of the invention. This casing 2 may be used in a cell that is otherwise of the type shown in FIG. 1. The casing 2 is of cylindrical form, with one open end and one closed end 9. Using aluminium for the casing 2 reduces the overall mass of the cell 1 by around 20%. Aluminium does suffer lithiation when in contact with Lithium, and therefore a barrier is required to prevent any contact occurring between the two materials inside the casing 2.

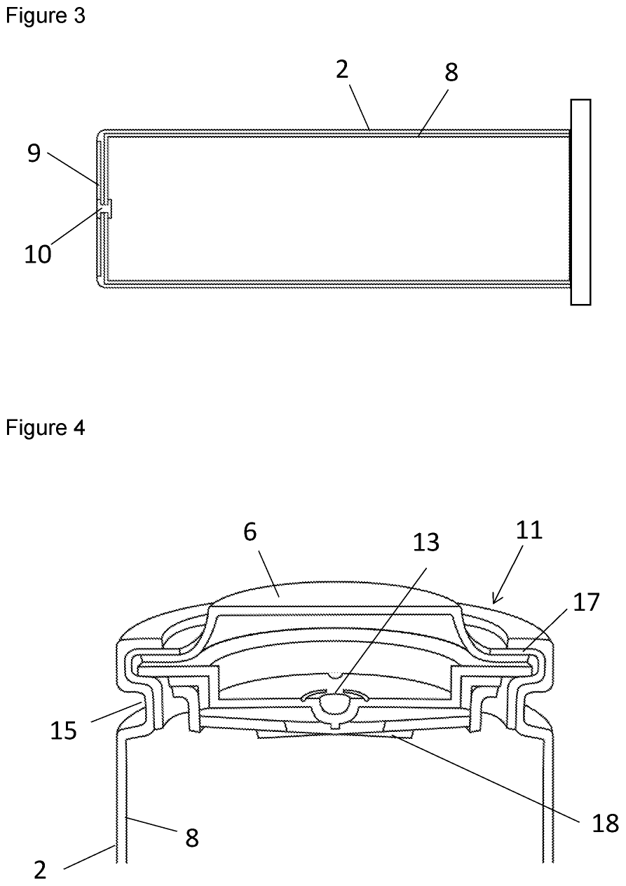

The exterior of typical Li-ion cells 1 is often covered with a thermoplastic sleeve providing electrical insulation since the casing 2 is negatively charged, and to carry branding and other identity. This sleeve may be printed with the brand and size of the battery. But the interior of a typical nickel-plated steel casing 2 is often left plain. Since the aluminium casing 2 would react with lithium-ion chemistry, the aluminium casing 2 requires a protective layer to prevent it from coming into contact with Lithium. The interior of the casing 2 is provided with a coating 8 (FIG. 3), where the coating comprises an electrically insulative plastics material. This plastics material may comprise a polymer plastic lining that shields the aluminium. One embodiment of plastics material may comprise a mixture of Polypropylene glycol monomethyl ether (25% to 50% weight), Dipropylene glycol monomethyl ether (10% to 25% weight), 1-Butanol (5% to 10% weight) and Polypropylene glycol monomethyl ether acetate (3% to 5% weight) with marginal amounts of other chemicals such as Dimethyl succinate, Phosphoric acid, Formaldehyde and 2-Methoxl-1-propanol. This plastics coating 8 is sprayed on the inside of the aluminium casing 2 to protect the aluminium from lithiation. Spraying a plastics coating inside aluminium casings is a well-established technique.

Preferably, the exterior of the casing 2 is not coated with the plastics material, nor coated with any form of thermoplastic sleeve, as this would add to the overall weight and may inhibit effective cooling of the cells 1.

FIG. 2A also shows one embodiment of a steel component in the form of a rivet 10, secured to the end 9 of the casing 2. FIG. 2B shows the end view of the casing 2 with the rivet 10 secured to the end 9 of the casing 2, where the casing 2 is made from aluminium and provided with coating 8 throughout the inside surface. FIG. 3 shows a section view of the rivet 10 secured to the end of the casing 2, and the coating 8 that lines the interior of the casing 2. The riveting action forms the exterior head of the rivet 10 and seals the inner head against the plastics coating 8.

The steel rivet 10 performs several functions. It provides a seal between the coating 8 on the inner surface of the aluminium casing 2 and the untreated outer surface of the casing 2. It prevents the liquid electrolyte leaking through the edge of the plastics coating 8 around the small central hole through which the rivet 10 passes, to the outer surface of the casing 2. To this end, the internal head of the rivet 10 presses down on the plastics coating 8 to form a seal. It allows for a conventional welding process used to manufacture standard Li-ion cells 1 to remain. With a standard cylindrical cell 1, the negative tab 20 is welded to the inner face of the casing 2 at the base and the casing 2, conventionally, is most likely to be of steel. This cannot happen with a plastics coating such as 8. The plastics coating 8 would be burnt away, exposing the aluminium below. Applying a rivet 10 is a cold working process and so it does not damage the plastics coating 8. The inner head of the rivet 10 provides a surface upon which to weld the negative tab 20, without compromising the aluminium coating 8.

To carry out such welding, before the upper components of cap 11 are fitted, a welding head passes down through the center hole 12 within the electrodes and welds the negative tab 20 to the inner head of the rivet 10. It is important to note that this welding process is largely unchanged from a conventional welding process, the only difference being that the negative tab 20 is welded to the inner head of the rivet 10, instead of to the inner surface of the end 9 of the casing 2. Thus, manufacture (typically automated) of Li-ion cells may proceed largely as at present, but with the internally coated aluminium casing 2 with steel rivet 10 replacing more conventional casings, such as steel casings.

Further functions of the rivet 10 include drawing away any excess heat experienced during the welding process, to the outer surface of the casing 2. The rivet 10 also provides a direct electrical connection to the outer surface of the aluminium casing 2. The outer face of the rivet 10 may also provide a robust welding face when electrically connecting multiple cells 1 together in series or parallel, when fabricating a battery pack. On standard cells 1 with steel casing 2, this is often a weak spot as the outer weld can adversely affect the inner weld, being only separated by 0.35 mm of steel.

The combination of plastics coating 8 throughout the inner surface of the aluminium casing 2 with the steel rivet 10 secured to the end of the casing 2, provides sufficient protection for the aluminium while allowing manufacturers to continue with standard manufacturing processes that are typically used to construct typical cylindrical cells 1. This avoids expensive re-tooling and education into new manufacturing techniques and handling of new materials.

FIG. 4 shows a typical positive terminal 6 but with the coating 8 applied throughout the internal surface of the casing 2. The coating 8 allows for a standard swage feature 15 to be retained and for standard manufacturing techniques to be used to prepare the cell 1. The standard manufacturing process for a typical lithium-ion battery cell 1 consists of three main steps. These are electrode manufacturing, cell assembly and finally cell finishing. For a cylindrical cell 1 the first step in the assembly process involves inserting the roll of electrodes into the cylindrical casing 2. The negative electrode tab 20 is then welded to the steel rivet 10 and the positive electrode tab 18 is welded to the cap 11.

To produce the aluminium casing 2 the following steps may be undertaken:
a) The casing 2 is impact extruded using an aluminium disc sitting in the bottom of a steel cylinder. A descending piston forces the aluminium material up between itself and the cylinder wall to form the casing 2.
b) A small hole for the rivet 10 is next punched into the base of the casing 2.
c) As may be seen in FIG. 3, a counterbore is formed at the base 9 of the aluminium casing 2, to provide a recess that allows an exterior head of the rivet 10 to be flush with the end of the casing 2. Due to the limits of the impact extrusion process, the exterior counterbore at the base of the casing 2 may need to be machined. An interior head of the rivet 10 fits inside the center of the casing 2 and inside the central hole 12. The counterbore may act as an area of weakness to provide a relief valve in the case of a ‘thermal event’.
d) Next the plastics coating 8 is sprayed onto the inside surface of the casing 2 before the rivet 10 is fitted. This is very important as it ensures that all the internal aluminium surfaces are coated, without the need for masking the face of the rivet 10.
e) Finally the rivet 10 is added. The rivet 10 provides a welding face for negative electrode tab 20 and also an electrical route to the outer surface of the casing 2.

If desired, a center pin may optionally be fitted in the central hole 12, after the negative electrode tab 20 has been welded to the inner surface of the rivet 10. Such a center pin may be hollow and contain an extinguishant that may be released into the cell, once ends of the center pin are opened by high temperature within the cell.

While the above description is concerned particularly with cylindrical lithium-ion cells, it may also be applied to prismatic lithium-ion cells and pouch lithium-ion cells.

While the above description is concerned particularly with rechargeable lithium-ion cells (secondary cells), it may also be applied to non-rechargeable lithium cells (primary cells).

It may be appreciated from the foregoing that illustrated embodiments of the invention may permit manufacture of lithium cells in a manner that is not greatly changed from that used widely at the present time. Once the aluminium casing 2 has been formed, coated internally and fitted with the steel rivet 10, subsequent steps of the manufacturing process may continue as currently practiced. The resultant cell 2 will be significantly lighter than conventional cells with steel casings or shells, without significant increase in cost.

The aluminium casing or shell 2 can greatly improve the thermal performance of any cylindrical cell. Aluminium may be 5 times better than steel and 15 times better than stainless steel at dissipating heat. This is an important advantage when used within high performance battery packs.

A positive electrode tab 18 and a negative electrode tab 20 are illustrated in the drawings and described above. However, it is possible for an electrode assembly to have multiple electrode tabs while, otherwise, the foregoing description may apply to such a configuration.

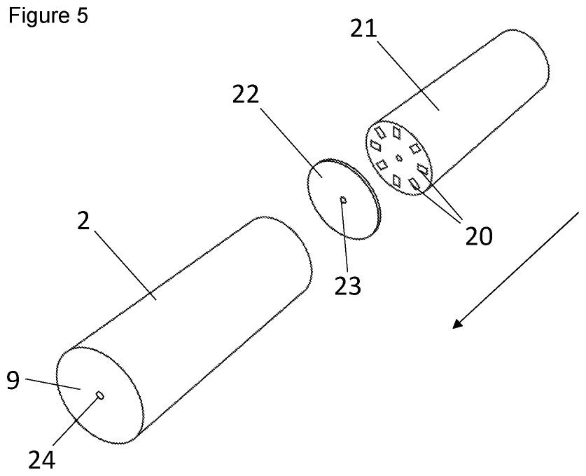

An example of this is shown in the diagrammatic exploded view of FIG. 5, where an electrode assembly 21 has a plurality of negative electrode tabs 20 that are electrically interconnected by a disc 22 (e.g. of copper). An aluminium casing 2 is provided, with a plastics insulating layer, much as described above. The electrode assembly 21 and disc 22 are inserted into the casing 2. A steel rivet passes through holes 23, 24 in the disc 22 and the end 9 of the casing 2 to provide, as described above, a negative terminal with the steel rivet in electrical contact with the aluminium casing. Other multi-tab interconnectors may be employed, of different configurations to the illustrated disc 22. A plurality of positive electrode tabs may also be provided.

While the above description discloses a metal component in the form of a steel rivet 10, components of other metals may be employed, where the metal of the component is less susceptible to lithiation than the aluminium of the casing 2. Various types of steel may be employed, including stainless steel. The metal component may have a protective coating—for example, to protect against corrosion.

In this specification, the verb “comprise” has its normal dictionary meaning, to denote non-exclusive inclusion. That is, use of the word “comprise” (or any of its derivatives) to include one feature or more, does not exclude the possibility of also including further features. The word “preferable” (or any of its derivatives) indicates one feature or more that is preferred but not essential.

All or any of the features disclosed in this specification (including any accompanying claims, abstract and drawings), and/or all or any of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent, or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1-22. (canceled)

23. A lithium cell comprising:
an aluminum casing;
a positive electrode and a negative electrode disposed within the aluminum casing with a separator between the positive electrode and the negative electrode;
an electrolyte;
a positive terminal connected to one of the positive electrode and the negative electrode; and
a negative terminal connected to the other of the positive electrode and the negative electrode:
wherein:
the aluminum casing includes an inner surface with a coating of a plastic material to prevent contact between the aluminum casing and internal active components of the lithium cell; and
at least one of the positive terminal and negative terminal comprises a metal component that is secured to the aluminum casing such that the metal component is in electrical contact with the aluminum casing, the metal component being less susceptible to lithiation than the aluminum of the aluminum casing.

24. The lithium cell of claim 23, wherein said metal component passes through a hole in the aluminum casing and has a head that engages with the coating to provide a seal between the inner surface with the coating and an outer surface of the aluminum casing.

25. The lithium cell of claim 23, wherein said metal component is a rivet that is riveted to the aluminum casing.

26. The lithium cell of claim 23, wherein said coating of a plastic material is a spray-applied coating inside the aluminum casing.

27. The lithium cell of claim 23, wherein one of the positive terminal and negative terminal comprises a steel cap that is secured to the aluminum casing.

28. The lithium cell of claim 27, wherein the steel cap is secured to the aluminum casing by swaging.

29. The lithium cell of claim 27, wherein said steel cap provides said positive terminal.

30. The lithium cell of claim 23, being of cylindrical configuration.

31. The lithium cell of claim 30, wherein said aluminum casing is cylindrical with one open end and one closed end and said metal component is secured to said closed end.

32. The lithium cell of claim 31, wherein the closed end of said casing is formed with an external recess within which an end of said metal component is located.

33. The lithium cell of claim 23, being of prismatic or pouch configuration.

34. The lithium cell of claim 23, wherein said coating of a plastic material comprises a polymer plastic.

35. The lithium cell of claim 23, wherein said metal component provides said negative terminal.

36. The lithium cell of claim 23, being a rechargeable lithium-ion cell.

37. A lithium battery comprising a plurality of lithium cells according to claim 23.

38. A method of manufacturing the lithium cell of claim 23, including the steps of fitting a metal rivet to the aluminum casing and welding an electrode tab to the metal rivet.

39. An aluminum casing with metal component for use in the lithium cell of claim 23.

40. A method of manufacturing an aluminum casing according to claim 39, including the steps of forming the aluminum casing and fitting a metal rivet to the aluminum casing.

41. The lithium cell of claim 23, wherein the metal of said component comprises steel.
